(19) United States
(12) Patent Application Publication
(10) Pub. No.: US 2026/0303581 A1
(43) Pub. Date: Oct. 1, 2026

(54) A Method for Authenticating a User at an Application, a Related User Device and a Related Server Device

(71) Applicant: SIDLABZ, Sint-Martens-Latem (BE)

(72) Inventor: Simon Maurice GHEYSENS, Sint-Martens-Latem (BE)

(73) Assignee: SIDLABZ, Sint-Martens-Latem (BE)

(21) Appl. No.: 19/481,726

(22) PCT Filed: May 3, 2024
(86) PCT No.: PCT/EP2024/062336

§ 371 Date: Nov. 5, 2025

(30) Foreign Application Priority Data
May 5, 2023 (BE) 2023/5369

(51) Int. Cl. H04L 9/40

(52) U.S. Cl. CPC H04L 63/061; H04L 63/08; H04L 63/10

(57) ABSTRACT

The invention relates to a method, a user computing device, a related server device for authenticating a user at an application being executed by a user computing device for obtaining access during a communication-session having a session-identification, to a user account of a webservice provided by a server.

### TECHNICAL FIELD

The present invention relates to a method for authenticating a user at a user computing device for access to a user account of a webservice provided by a server device, a related user device and server device.

### BACKGROUND ART

Currently smartphone applications and or webservices use SMS receive method for authentication of users being 2 factor authentication, meaning that the user enters his phone number manually and requests a SMS with a code to login into an application.

Such method is disadvantageous in that due to user interface problems only 60 to 70% of potential users succeed in authentication with an app. This is typically due to a typing mismatch between the actual phone number and the entered telephone number, resulting in multiple retries and user friction to authenticate users, resulting in drop-off. Moreover, such 2-factor authentication stills suffer from issues with respect to security as phone numbers can be spoofed, impersonating individuals leading to fraud, identity theft, unauthorized access, and more.

### DISCLOSURE OF THE INVENTION

It is an object of the present invention to provide a method for authenticating a user at user computing device for access to a user account of a webservice, a related system, a related user computing device and a related server device that overcomes or alleviates these mentioned problems.

Indeed, this objective is achieved by at accessing said webservice by said application of said user computing device, first determining, by said user computing device UD, at least one unique user identifier of said user computing device and subsequently generating, by said user computing device, a first secure key based on said at least one unique user identifier of said user computing device and sending by said user computing device said first secure key to said server device; and generating, by said user computing device (1) or said server device (2) based on said first unique secure key and a session-identification of a communication session of authenticating a user, a second unique secure key, where said second unique secure key being different from said first secure key and sending said second unique secure key and said session-identification to said server device (2) and/or said user computing device (1) followed by generating, by said user computing device, an authentication message comprising said second unique secure key and a phone number of said user computing device for sending to said webservice and subsequently authenticating said user computing device for said communication-session by said server device, if said second unique secure key retrieved from said authentication message at receipt of said message matches said second unique secure key from maintained at said webservice, being associated with said session-identification, provided by said server device (2); and further at authentication, registering by said server device (2) said phone number of said user computing device (1) as origin of said authentication message; and providing access, by said webservice, to said user computing device (1) at authentication of said user computing device by sending a login message to said user computing device (1).

In this way, at least one uniquely identifying user identifier of said user computing device is applied for uniquely identifying the user computing device and optionally an associated user account based on the unique characteristics user computing device of the user and optionally of the associated user account. Subsequently, the user computing device generates a first secure key based on the at least one unique user identifier of said user computing device where this first secure key is a unique identifier of the user computing device and optionally an associated user account.

Either one of the user computing device (1) and the said server device (2) generates based on said first unique secure key and a session-identification of a communication session of authenticating a user wherein said session identification optionally comprises a timestamp, a second unique secure key, said second unique secure key being different from said first secure key; whereafter the second unique secure key and said session-identification are transmitted to the said server device (2) or to the said user computing device (1) depending on the whether the user computing device or the server device generated the second secure key.

Said user computing device subsequently generates an authentication message comprising said second unique secure key and a phone number of said user computing device (1) for sending to said webservice. By optionally applying an SMS or WhatsApp message wherein the originating and associated telephone number are incorporated in the message by nature, it is not necessary to explicitly and additionally add the phone-number of the originating party besides the second secure key.

Said server device (2), at receipt of said message, authenticates said user computing device if said second unique secure key retrieved from said authentication message matches said second unique secure key maintained at said server device, being associated with said session-identification, provided by said server device (2) as the server devices obtained the confirmation of the identity of the user computing device and additionally at authentication, the server device (2) registers said phone number of said user computing device (1) as origin and finally provides access, to said user computing device (1) at authentication of said user computing device the webservice provides the application with access to the webservice by means of an app notification message.

The application according to embodiments of the present invention may be an android or IOS app or equivalent app, for accessing a webservice, that can be installed on the user computing device but alternatively may be a web browser accessing a webpage providing with access to the webservice. The user computing device according to embodiment of the present invention may be a mobile phone, a tablet computing device, a mobile computer such as a laptop but may alternatively be any other suitable computing device.

The at least one unique user identifier of said user computing device may be a combination of device identifiers uniquely identifying the user computing device and or the user and the active session thereof. Examples of such unique user identifier of said user computing device may be the IMEI number the sim-code of the phone subscription or any identification number of components of such user computing device such as a microprocessor, memory and or communication circuits.

The at least one unique user identifier of said user computing device is applied to uniquely identifies an account of a user of said user computing device due to the unique character of this identifier. This identifier additionally or alternatively may be hashed or encrypted to conceal the identity of—or the identifiers of the user computing device.

The authentication message may be a short service message, a WhatsApp message, or any phone number authenticated service being based on the phone subscription of the user computing device

A further relevant embodiment of the present invention relates to the

Method according to claim 1, wherein said method further comprises the step of transmitting said authentication message from said user computing device 1 to said server device 2 over a message gateway 3 coupled over a public network (PN).

The authentication message is sent from the user computing device towards the server device over a message gateway which may be a SMS message gateway, a WhatsApp message gateway or other equivalent message gateway to which gateway both the user computing device and the server device are coupled over a public communications network. A further relevant embodiment of the present invention relates to the method according to claim 1, wherein said method further comprises the step of transmitting said first secure key from said user computing device (1) to said server device (2) over an encrypted private connection (EPC). and to the method according to claim 1, wherein said method further comprises the step of transmitting said session-identification from said user computing device (1) to said server device (2) over an encrypted private connection (EPC). Both the first secure key as the session-identification are communicated over an encrypted private connection coupling the respective communication means of the user computing device and the server device.

The first secure key is transmitted only at initialization but the session identification is transmitted each time a new communication session between the user computing device and the server device is established.

A further relevant embodiment of the present invention relates to the method for wherein said method additionally comprises the step of:
matching, by said webservice, at receipt of said authentication message, said telephone number and said at least one unique user identifier of said user computing device included in said authentication message; and
requesting, by said webservice, validation of a user computing device if said at least one unique user identifier of said user computing device does not match; and
, coupling said at least one unique user identifier of said user computing device with said account for said user of said user computing device at validation of said of said user computing device.

In this way by matching, at receipt of said authentication message, said telephone number and said at least one unique user identifier of said user computing device included in said authentication message and in case said at least one unique user identifier of said user computing device does not match, because e.g. another device with at least one user identifier not known to the webservice, is used by this user, said webservice requests, to validate the user computing device to be able to couple said at least one unique user identifier of said user computing device with said account for said user wherein the validation can be performed by acknowledging the at least one user identifier of the to be added device by means of personal information such as an email address included in the account, e.g. via an email verification process.

In other words, in case a user intends to use a user computing device which is not registered at the server device while using the same phone number the user is allowed to add such a device by validating this user computing device, i.e. if the at least one unique user identifier of said user computing device included in said authentication message does not match with the account data where this validating of the this user computing device can be performed using personal information such as an email address incorporated in the account of the user.

A further relevant embodiment of the present invention relates to a method according to claim 1, wherein said step of generating said first secure key is performed by applying a hash function on said at least one unique user identifier of said user computing device.

The first secure key may be generated by means of applying a hashing algorithm, such as the bcrypt algorithm or equivalent algorithms, to said at least one unique user identifier of said user computing device. Any combination of the at least one unique user identifier of said user computing device may be used as an input to the hashing algorithm for generating the first secure key in a unique and secure manner in that sense that the originating at least one unique user identifier of said user computing device cannot be retrieved from the generated first secure key. Such hashing algorithm may be applied with or without incorporating the step of salting.

Another further relevant embodiment of the present invention relates to a Method according to claim 1 or 2, wherein said step of generating said second secure key performed by applying a hash function on said first unique secure key and optionally said session-identification (of a session of authenticating a user).

The second secure key may be generated by means of applying a hashing algorithm, such as “bcrypt” or equivalent algorithms, to said first unique secure key and optionally said session-identification (of a session of authenticating a user). Such hashing algorithm may be applied with or without incorporating the step of salting.

The said first unique secure key and optionally said session-identification (of a session of authenticating a user) may be used as an input to the hashing algorithm for generating the unique second secure key in a secure manner in that sense that the originating at least one unique user identifier of said user computing device cannot be retrieved from the generated first secure key.

Another further relevant embodiment of the present invention relates to a Method according to any of claims 1 to 4, wherein said method additionally comprises the step of retrieving said second unique secure key by parsing, said authentication message to deduce said unique secure key for said phone number of said user computing device, upon receipt of said authentication message.

The second secure key can be derived from the received authentication message by parsing, said authentication message, for an instance being an SMS, WhatsApp-, Signal message or equivalent message to deduce the second unique secure key for said phone number of said user computing device, upon receipt of said authentication message.

Still another relevant embodiment to the present invention relates to the method according to claim 1, wherein said method additionally comprises the steps of:
transmitting, by said user computing device, account information of said user to said server device; and
matching, by said server device, at receipt of said authentication message, said second secure key for said session identification included in said authentication message, said second secure key being associated with said session-identification being maintained at said server device; and
requesting, by said server device, validation of a user computing device if said second secure key matches, using said account-information of said user; and
coupling said user computing device with said account for said user of said user computing device at validation of said user computing device.

The step of transmitting by said user computing device, of account information of said user to said server device is a registration step of the user at the webservice. Further, at receipt of said authentication message at the server device 2, said second secure key for said session identification included in said authentication message is matched with said second secure key being associated with said session-identification being maintained at said server device. Subsequently, if said second secure key matches, said server device requests the validation of a user computing device using said account-information of said user. The account-information may include at least one email address of the user which email address can be applied for requesting the user to validate the user computing device and finally at validation of the user computing device by the user, coupling said user computing device with said account for said user of said user computing device at validation of said user computing device 1.

Another relevant embodiment of the present invention relates to the method wherein said authentication message is an SMS message or WhatsApp message or equivalent.

### BRIEF DESCRIPTION OF THE DRAWINGS

The invention will be further elucidated by means of the following description and the appended figures.

FIG. 1 represents a system for authenticating a user at an application being executed by a user computing device for obtaining access to a user account of a webservice

FIG. 2 represents the functional elements of the user computing device 1 with the server device 2 according to embodiments of the present invention.

FIG. 3 represents a system for authenticating a user at an application being executed by a user computing device for obtaining access to a user account of a webservice and the associated information-flow and with associated actions

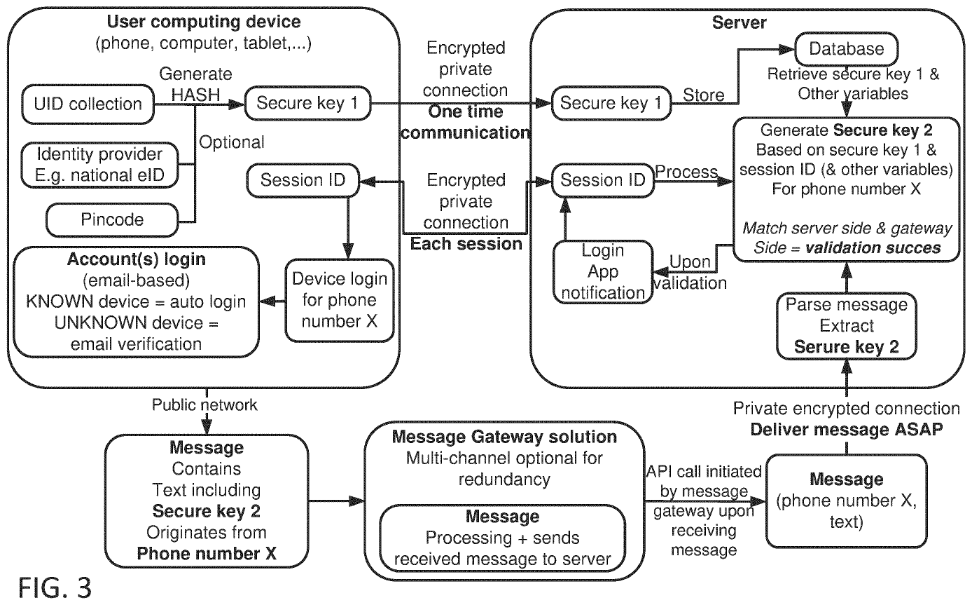

### MODES FOR CARRYING OUT EMBODIMENTS OF THE PRESENT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

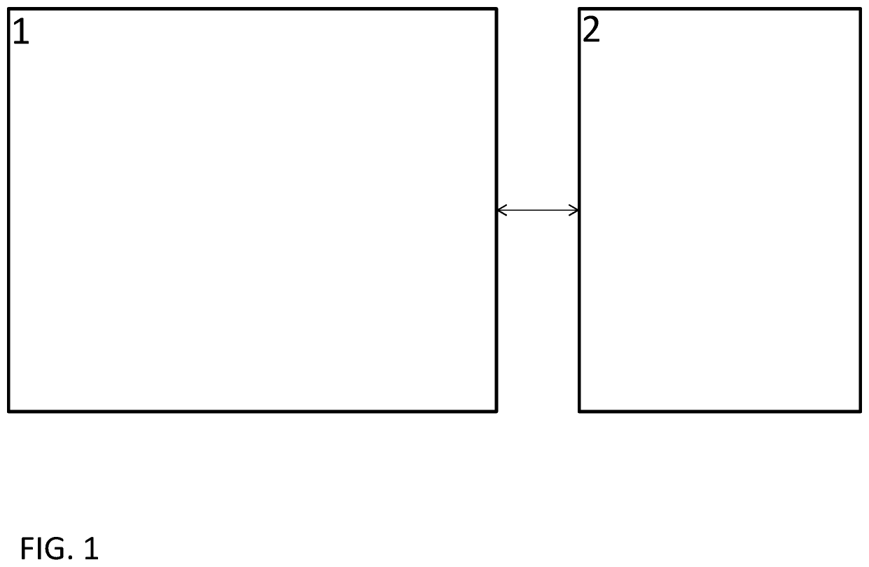

In the following paragraphs, referring to the drawing in FIG. 1, an implementation of the system for authenticating a user at an application being executed by a user computing device for obtaining access to a user account of a webservice according to an embodiment of the present invention is described.

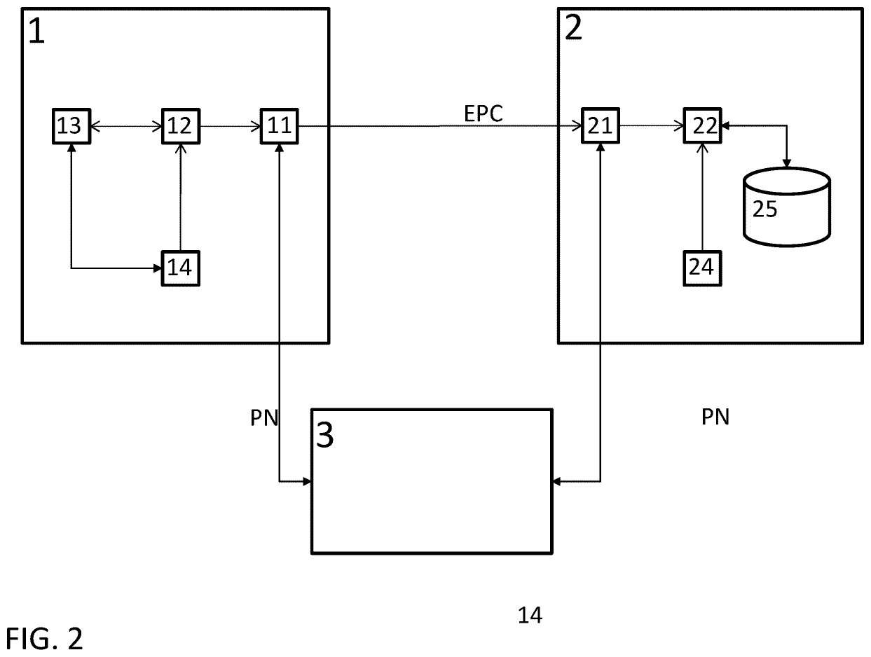

In a further paragraph, all connections between mentioned elements are defined. Subsequently all relevant functional means of the system for system for authenticating a user at an application being executed by a user computing device for obtaining access to a user account of a webservice as presented in FIG. 2 are described followed by a description of all interconnections.

In the succeeding paragraph the actual execution of authenticating a user at an application being executed by a user computing device for obtaining access to a user account of a webservice according to an embodiment of the present invention is described under control of the system is described.

A first essential element of the system is a user computing device 1 such as an iPhone, an iPad, or Android devices such as an Android smartphone or Android tablet computer or even laptop computer. Such a user computing device 1 is configured to install a multiplicity of different kind of applications where the execution of each such application is meant for performing a different kind of task. Such a plurality of applications, further referred to as “apps”, may include all kinds of types of applications, each with a corresponding purpose and characteristics, such as apps for reading the news, chat-apps, mail apps, browser-apps, travel-planner apps, banking apps etc.

The user computing device, such as for instance a smart phone or a tablet computer typically comprises a display for presenting such a plurality of apps on the screen or display where each app of the plurality of applications, typically is presented by means of an icon corresponding to the application. Such application, at selection of the application by a user of the mobile device, is opened and displayed at the full screen or a substantial part thereof, which is called a view of an application. Alternatively, such an application can be accessed via a browser installed on the user computing device.

Examples of such applications are iOS apps being installed at an iPhone or iPad or Android apps being executed at an Android device like Android smartphone or tablet. Alternatively, for any user computing device such as laptop computer, mobile phone or tablet may be also applicable to access the webservice via the browsing application and webpage corresponding to a certain user application.

Further, such a system may consist of a server device 2 that may be a web server device or alternatively a local or distributed server that is configured to determine and provide the user application either via the app or via the browser application with a service or content.

Such user computing device 1 and the web server device 2 may be coupled over a wireless connection such as wireless networks include cell phone networks, wireless local area networks (WLANs), wireless sensor networks, satellite communication networks or any alternative suitable communications networks optionally in combination with possible fixed networks.

The user computing device 1 may comprise an interfacing means 13 comprising a display for presenting apps on the screen or display where each application of the plurality of applications, typically is presented by means of an icon corresponding to the application. Such application, at selection of the application by a user of the mobile device, is opened and displayed at the full screen or a substantial part thereof, which is called a view of an application. The interfacing means 13 further may comprise a keyboard or voice interface for entering data.

The user computing device 1 further comprises a communications means 11 which may implement the wireless communication such as the voice communication and the data communication via (3G, 4G, 5G etc.,) Wireless Local Area Networks (WLANs) but additionally or alternatively being coupled over fixed communication networks. The user computing device 1 further comprises a memory means 14 that is configured to store the apps and amongst other may comprise a part of random access memory for storing temporary data while executing the apps. This temporary data may comprise all variables that define a view of such application being executed.

Further, the user computing device 1 may comprise processing means 12 for actually executing an application and processing all relevant data.

The server device 2 may comprise a communications means 21 which typically implements communication via mobile networks (3G, 4G, 5G etc.,) wireless local area networks (WLANs) additionally or alternatively fixed networks communication.

The user computing device 1 further comprises a memory means 24 that is configured to store the application logic of the application to be provided to the user computing device of each corresponding user and amongst other may comprise a part of random access memory for storing temporary data while executing the apps. This temporary data may comprise any data corresponding to such application being executed.

Further, the user computing device 1 may comprise processing means 22 being processor such as for actually executing an application and processing all relevant data.

In order to explain an embodiment of the present invention it is assumed that the user of the user computing device 1 intends to access a certain application for providing the user with a service or content.

Hereto the user needs to be authenticated at an application being executed by said user computing device 1 for obtaining access to a user account of a webservice provided by or executed at server device 2.

At first after installation of the meant app at the user computing device 1, the processing means 12 of the user computing device first determine, at least one unique user identifier of said user computing device, where the at least one unique user identifier uniquely identifying said user computing device 1.

The at least one unique user identifier of said user computing device may be a combination of device identifiers uniquely identifying the user computing device 1 and or the user and or the session thereof. Examples of such unique user identifier of said user computing device may be the device ID, the IMEI number, the sim-code of the phone subscription or any identification number of components of such user computing device such as a series number of the incorporated microprocessor, a series number memory or a series number of the communication circuits.

The at least one unique user identifier of said user computing device is applied to uniquely identify the user computing device due to the unique character of these identifiers.

Subsequently, the processing means 12 of the user computing device generates a first secure key based on said at least one unique user identifier of said user computing device determined, for instance by applying a hash function to said at least one unique user identifier of said user computing device.

The first secure key may be generated by means of applying a hashing algorithm, such as “bcrypt” or equivalent algorithms, or any encryption algorithm to said at least one unique user identifier of said user computing device. Any combination of the at least one unique user identifier of said user computing device may be used as an input to the hashing algorithm for generating the first secure key in a unique and secure manner in that sense that the originating at least one unique user identifier of said user computing device cannot be retrieved from the generated first secure key. Such hashing algorithm may be applied with or without incorporating the step of salting.

The processing means 12 of the user computing device after generation of the first secure key instructs the communication means 11 of the user computing device 1 to send said first secure key to the communications means 21 of the said server device 2 for storage at a repository 25 for storing account information on subscribers of the webservice executed at the server device 2.

Based on said first unique secure key and a session-identification of a communication session of authenticating a user, a second unique secure key is generated at a processing means 12 of said user computing device or processing means 22 of the server device 2. The second unique secure key is generated in such manner that this second secure key is different from said first secure key.

The second secure key may be generated by means of applying a hashing algorithm, such as “bcrypt” algorithm or equivalent algorithms, or any encryption algorithm to said first unique secure key and optionally said session-identification (of a session of authenticating a user). Such hashing algorithm may be applied with or without incorporating the step of salting.

The said first unique secure key and optionally said session-identification (of a session of authenticating a user) may be used as an input to the hashing algorithm for generating the unique second secure key in a secure manner in that sense that the originating at least one unique user identifier of said user computing device cannot be retrieved from the generated first secure key.

The generated second secure key is either send to the communication means 21 of the server device 2 if the second secure key is generated at the user computing device 1 or transmitted by the communication means 21 of the server device 2 to the communication means 11 of the user computing device 1 in case if the second secure key is generated by the server device 1.

Subsequently the processing means 12 of said user computing device 1 generate, an authentication message comprising said second unique secure key and a phone number of said user computing device (1) for sending by means of the communication means 11 to said server device 2; and

The processing means (21) subsequently upon reception of the authentication message authenticates said user computing device (1) for said communication-session, if said second unique secure key retrieved from said authentication message matches said second unique secure key maintained at the repository 25 of the server device, where this second secure key is associated with said session-identification which is provided by said server device (2); and the processing means (21) subsequently registers, at authentication, said phone number of said user computing device (1) as origin of said authentication message at the repository 25 of the server device 2.

The processing means 22 subsequently provides access to said user computing device 1 at authentication of said user computing device by instructing the communication means 21 to send a login message to said user computing device and the communication means 21 transmitting this login message to said user computing device 1 that in turn by means of the communications means 11 receives this login message whereafter the processing means (12) further provides access of said application to said webservice at authentication of said user computing device at receipt of a login message from said server device 2 applying information from said login message.

The processing means 22 of the server device 2 retrieves said second unique secure key by parsing the authentication message to deduce said unique secure key for said phone number of said user computing device, upon receipt of said authentication message. The second secure key can derive from the received authentication message by parsing, said authentication message, for an instance being an SMS, WhatsApp-, Signal message or equivalent message to deduce the second unique secure key for said phone number of said user computing device, upon receipt of said authentication message.

It is further to be noticed that, the authentication message is sent from the user computing device towards the server device over a message gateway which may be a SMS message gateway, a WhatsApp message gateway or other equivalent message gateway to which gateway both the user computing device and the server device are coupled over a public communications network. Furthermore, both the first secure key as the session-identification are communicated over an encrypted private connection coupling the respective communication means of the user computing device and the server device.

The first secure key is transmitted only at initialization but the session identification is transmitted each time a new communication session between the user computing device and the server device is established.

Further, at receipt of said authentication message at the server device 2, said second secure key for said session identification included in said authentication message is matched with said second secure key being associated with said session-identification being maintained at said server device. Subsequently, if said second secure key matches, said server device requests the validation of a user computing device using said account-information of said user. The account-information may include at least one email address of the user which email address can be applied for requesting the user to validate the user computing device and finally at validation of the user computing device by the user, coupling said user computing device with said account for said user of said user computing device at validation of said user computing device 1.

A further advantageous embodiment of the present invention is that for generation of the first and second secure key, a government authentication certificate, or equivalent authentication certificate can be applied as an additional input for the hashing algorithm as earlier described.

This government authentication certificate or equivalent certification certificate preferably is stored at a secure storage element for instance at the user computing device or server device. Such additional authentication certificate may be generated by a certain application based on a token with a pincode.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is made only by way of example and not as a limitation on the scope of the invention, as defined in the appended claims

1. A method for authenticating a user at an application being executed by a user computing device (1) for obtaining access during a communication-session having a session-identification, to a user account of a webservice provided by a server device (2), wherein said method comprises the step of:
determining, by said user computing device (UD) at least one unique user identifier of said user computing device; and
generating, by said user computing device (UD) a first secure key based on at least one unique user identifier of said user computing device; and
sending by said user computing device (UD) said first secure key to said server device (2); and
generating, by said user computing device (1) or said server device (2) based on said first unique secure key and a session-identification of a communication session of authenticating a user, a second unique secure key, said second unique secure key being different from said first secure key; and sending said second unique secure key and said session-identification to said server device (2) and/or said user computing device (1); and
generating, by said user computing device, an authentication message comprising said second unique secure key phone number of said user computing device (1) for sending to said server device 2; and
authenticating said user computing device (1) for said communication-session, by said server device (2), if said second unique secure key retrieved from said authentication message at receipt of said message matches said second unique secure key maintained at said server device 2, being associated with said session-identification, provided by said server device (2); and
at authentication, registering by said server device (2) said phone number of said user computing device (1) as origin; and
providing access, by said webservice, to said user computing device (1) at authentication of said user computing device by sending a login message to said user computing device (1).

2. The method according to claim 1, wherein said step of generating said first secure key is performed by applying a hash function to said at least one unique user identifier of said user computing device.

3. The method according to claim 1, wherein said step of generating said second secure key performed by applying a hash function on said first unique secure key and optionally said session-identification of a session of authenticating a user.

4. The method according to claim 1, wherein said method further comprises the step of transmitting said authentication message from said user computing device (1) to said server device (2) over a message gateway (3) coupled over a public network (PN).

5. The method according to claim 1, wherein said method further comprises the step of transmitting said first secure key from said user computing device (1) to said server device (2) over an encrypted private connection (EPC).

6. The method according to claim 1, wherein said method further comprises the step of transmitting said session-identification from said user computing device (1) to said server device (2) over an encrypted private connection (EPC).

7. The method according to claim 1, wherein said method further comprises the step of updating said server device if said second secure key is generated by said user computing device.

8. The method according to claim 1, wherein said method additionally comprises the step of retrieving said second unique secure key by parsing, said authentication message to deduce said unique secure key for said phone number of said user computing device, upon receipt of said authentication message.

9. The method according to claim 1, wherein said authentication message is an SMS message or WhatsApp message or equivalent.

10. The method according to claim 1, wherein said method additionally comprises the steps of:
transmitting, by said user computing device, account information of said user to said server device; and
matching, by said server device, at receipt of said authentication message, said second secure key for said session identification included in said authentication message, said second secure key being associated with said session-identification being maintained at said server device; and
requesting, by said server device, validation of a user computing device if said second secure key matches, using said account-information of said user; and
coupling said user computing device with said account for said user of said user computing device at validation of said user computing device.

11. A user computing device (UD) for authenticating a user at an application being executed by said user computing device (UD) for obtaining access, during a communication-session having a session-identification, to a user account of a webservice provided by a server device (2), wherein said user computing device (1) comprises a processing means (11) configured to:
determine, at least one unique user identifier of said user computing device, for uniquely identifying said user computing device; and
generate a first secure key based on said at least one unique user identifier of said user computing device; and
instruct to send said first secure key to said server device (2); and
optionally generate, based on said first unique secure key and a session-identification of a communication session of authenticating a user, a second unique secure key, said second unique secure key being different from said first secure key; and sending said second unique secure key and said session-identification to said server device (2); and
generate, an authentication message comprising said second unique secure key and a phone number of said user computing device (1) for sending to said webservice; and
provide access of said application to said webservice at authentication of said user computing device at receipt of a login message from said server device (2) applying information from said login message.

12. A server device (2) for authenticating a user at an application being executed by a user computing device (1) for obtaining access, during a communication-session having a session-identification, to a user account of a webservice provided by said server device (1), wherein said server device (1) comprises:
a communication means (21) configured to
receive a first secure key and said session-identification from said user computing device (1); and said server device (2) further comprises a processing means (22) configured to:
optionally generate, based on said first unique secure key and said session-identification of a communication session of authenticating a user, a second unique secure key, said second unique secure key being different from said first secure key; and
a communication means (21) configured to transmit said second unique secure key and said session-identification to said user computing device (1); and
said communication means (21) further configured to receive an authentication message comprising said second unique secure key and a phone number of said user computing device (1) from said user computing device (2); and
said processing means (22) further being configured to:
authenticate said user computing device (1) for said communication-session, if said second unique secure key retrieved from said authentication message at reception of said message matches said second unique secure key maintained at said webservice, being associated with said session-identification, provided by said server device (2); and
register, at authentication, said phone number of said user computing device (1) as origin of said authentication message; and
provide access, to said user computing device (1) at authentication of said user computing device by instructing to send a login message to said user computing device (1); and
said communication means (21) configured to transmit a login message to said user computing device (1).

13. A system for authenticating a user at an application being executed by a user computing device, for obtaining access to a user account of a webservice provided by a server device, said system comprising:
a user computing device (1) according to claim 11.

14. The system according to claim 13, further comprising a server device (2) according to claim 12.
